(19) United States
(12) Patent Application Publication
(10) Pub. No.: US 2004/0003503 A1
(43) Pub. Date: Jan. 8, 2004

(54) Modular hand-held power tool system

(76) Inventor: Jon Anthony McDonald, Woodland Hills, CA (US)

Correspondence Address: Marshall E. Rosenberg, Esq., The Gilbert Law Building, 22130 Clarendon Street, Woodland Hills, CA, 91367, US

(21) Appl. No.: 10/284,047

(22) Filed: Oct. 29, 2002

Related U.S. Application Data
(60) Provisional application No. 60/345,016, filed on Oct. 29, 2001.

(51) Int. Cl. B27B 17/02

(52) U.S. Cl. 30/383

(57) ABSTRACT

A modular power tool system utilizing a modular, self-contained power drive system is disclosed. The system includes a power tool head such as a rotary cutting saw, drill or sander. The power tool head is driven by a selectively attachable, self-contained power source, to be readily secured for rotation to the power tool head by a quick-release collar. Each modular component is selectively operable with cooperating modular components.

### CROSS REFERENCE TO RELATED APPLICATIONS

This application claims the benefit of U.S. Provisional Application No. 60/345,016, filed Oct. 29, 2001.

### STATEMENT REGARDING FEDERALLY SPONSORED RESEARCH OR DEVELOPMENT

Not applicable.

### BACKGROUND OF THE INVENTION

1. Field of the Invention

The present invention relates to portable tools such as hand-held power-assisted tools, and more particularly, to a power tool adapted to drive a material processing tool under power provided by a modular power source.

2. Description of the Related Art

Portable power tools, including hand-held power tools, are well known and widely used for processing a broad range of materials, whether rough-cutting timber, scoring concrete, or trim-finishing final details. Such tools are commonly provided with processing tools that may include but are not limited to saw blades, drill bits, sanding heads, vibrating heads, and other devices intended to perform a processing step on a selected material.

Whether intended for punishing professional and commercial use or occasional light-duty hobbyist use, such tools are by their very nature expected to provide long lives with dependable reliability. Yet, any kind of machine is prone to mechanical failure in addition to the need for periodic maintenance. This fact is especially true for commercial applications. Although power equipment intended for commercial and professional applications is typically engineered to withstand the additional rigors of the workplace, even that equipment is subject to mechanical breakdowns and failures. The resulting down-time may negatively effect tightly-scheduled construction deadlines, further negatively impacting the scheduling of interdependent work scheduled to be performed by counterpart trade workers. Accordingly, there is a long-felt but unfulfilled need to provide apparatus that will enable the rapid return of a power tool to service with a minimum amount of downtime, preferably only that downtime necessary to effect the changes provided by the present invention.

Additionally, portable tools require a power supply for powering the tool as required. According to the related art, the user of such a tool must either transport such a separate power generating unit with him from place to place in order to obtain full use of the tool, or alternatively, provide the power supply as a necessary component of the tool. It is known to provide an electric-powered motor as an integral component for hand tools such as drills, screwdrivers, and other relatively light duty applications. With respect to electrically powered cutting tools presently known to the art, such tools have generally required either a separate power source, such as may be provided by a building electrical supply, or alternatively, via battery power. In the former case of a separate electrical power source, as with the gasoline generated rotary cutting tool, the user of such a tool must be certain of an available power source. This may be of particular difficulty or even impossible if the user intends use of such an electrical power tool in an outside location, particularly if such location is not linked to the electrical grid.

Accordingly, the user of the electrical power tool must thus rely upon battery power, which requires prior electrical charging of the electrical storage cells upon which the electrical power tool will draw from. Moreover, a sufficient number of power cells or batteries with sufficient electrical storage capacity must be provided to meet the anticipated needs of the user. It will be further appreciated that power needs and available power capacity will be dependent on power tool loading during use, which most power systems cannot predictably determine in advance.

In addition, it is generally well known that battery powered tools are particularly sensitive to weather conditions. For example, moisture and, particularly, cold weather can seriously diminish the life span of a particular charge therefore raising the question of whether sufficient power will be available to complete a particular job. Moreover, even a battery which may be charged and recharged many times will, over time, lose its effective power capacity and will eventually no longer be able to be recharged to provide desired power capacity. Short of providing additional electrical storage batteries on a demand-basis, the user cannot opt for an alternative or substitute power supply or source in the field when the need is greatest and replacement or supplement parts, supplies and labor may not be available.

In response to these concerns, power hand-tools having integrated gasoline-fueled power sources are known for use in connection with gardening and agricultural use, such as for trimming lawns, shrubs and overgrowth, thereby providing true portability for that type of power hand tool. What is needed, but not provided to date, is a portable power hand-tool benefitting from the true portability of a gasoline engine power source, and which overcomes shortcomings of the prior art.

### OBJECTS AND SUMMARY OF THE INVENTION

Accordingly, it is an object of the present invention to provide a modular system for enabling near-continuous operation of a power-assisted hand-tool, subject only to replacement of essential modular aspects of the system as the need arises to return the hand-tool to service, by proving a modular construction including a truly portable power source.

It is another object of the present invention to provide such a novel modular power and material processing system that is universally applicable across related or unrelated brand or product lines, whether by product type, product configuration, or other common aspects configurable according to the teachings of the present invention.

It is a further object of the present invention to provide such a system for use with power-assisted hand tools including but not limited to power cutting saws, such as rotary saws.

It is yet another object of the present invention to provide material processing tools for use therewith for processing without limitation a variety of materials, including but not limited to concrete, wood, masonry, ceramics, and polymeric substances.

It is yet a further object of the present invention to provide such a system while maintaining the operational integrity of additional performance features of the power-assisted hand tool.

These and other object and advantages are obtained with a modular power tool system utilizing a modular, self-contained power drive system. The system includes a power tool head such as a rotary cutting saw. The power tool head is driven by a selectively attachable, self-contained power source, to be readily secured for rotation to the power tool head by a quick-release collar.

The invention will be better understood upon a reading of the following specification, read in conjunction with the accompanying drawings.

### BRIEF DESCRIPTION OF THE DRAWINGS

FIG. 1 is an elevational view of one side of an assembled modular, portable power-assisted hand-tool of the present invention.

FIG. 2 is an exploded perspective view of the power-assisted tool shown in FIG. 1.

FIG. 3 is an exploded view of the drive shaft of the modular power source and the power input apparatus of the present invention.

FIG. 4 is a view of the apparatus of FIG. 3 shown in the fully assembled condition.

FIG. 5 is an elevational view of the modular power source and connecting hardware taking along line 5-5 of FIG. 2.

FIG. 6 is an elevational view of the power input apparatus (power saw in this instance) and connecting hardware taken along line 6-6 of FIG. 2.

FIG. 7 is a side elevational view of the assembled modular, portable power-assisted hand-tool shown in FIG. 1, further mounted in a tool support accessory.

FIG. 8 is a partial sectional view of the joining apparatus of FIG. 4 taken along line 8-8, further showing a splined connection of the present invention.

### DESCRIPTION OF THE INVENTION

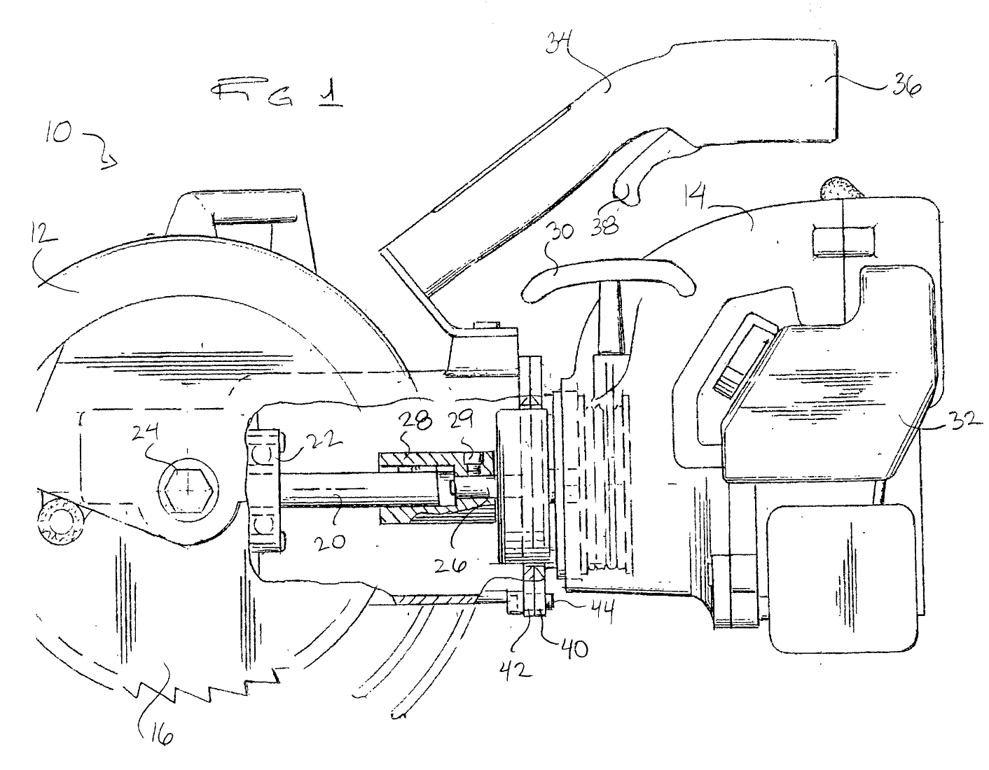

With reference now to the drawings, and according to the present invention, the system 10 mates a power tool head 12 to a modular, self-contained power drive system 14. The power tool head 12 may include a material processor such as a rotary cutting saw blade 16 affixed for rotation within a housing and blade guide 18, as shown in FIG. 1, or other material processing equipment including but not limited to other types of saw blades, drill bits, sanding heads, vibrating heads, and other devices intended to perform a processing step on a selected material. The saw blade 16 is secured for rotation by a drive shaft 20 acting through a transmission means 22, the saw blade 16 being removably affixed to the transmission means 22 by a bolt 24.

According to the present invention, the self-contained power drive system 14 may be a gasoline-fuieled power source having a power output shaft 26 acting though a coupler 28 for engaging drive shaft 20 of the power tool head 12. The power drive system 14 according to a preferred embodiment of the present invention is a gasoline-powered drive unit shown herein with a manually-operated clutched pull-starter 30, although electric starter apparatus may be employed. As described above, the power drive system 14 incorporates a self-contained fuel source such as a gasoline tank 32 for providing maximum portability and independence. In use, the modular hand-held power tool system 10 in the fully assembled and operative condition is supported by an operating handle 34 with a hand grip 36 to which a finger-actuated power switch 38 is secured. As will be appreciated by the skilled artisan, the entirety of the self-contained system 10 has been determined to weigh less than 22 pounds, even when mounted to a roller platform having ground-engaging wheels sold as an accessory for use with and intended to carry the majority of the weight of the tool during use, that accessory sold under the trademark ROLLER BLADE (™), owned by the inventor of the present invention (FIG. 7).

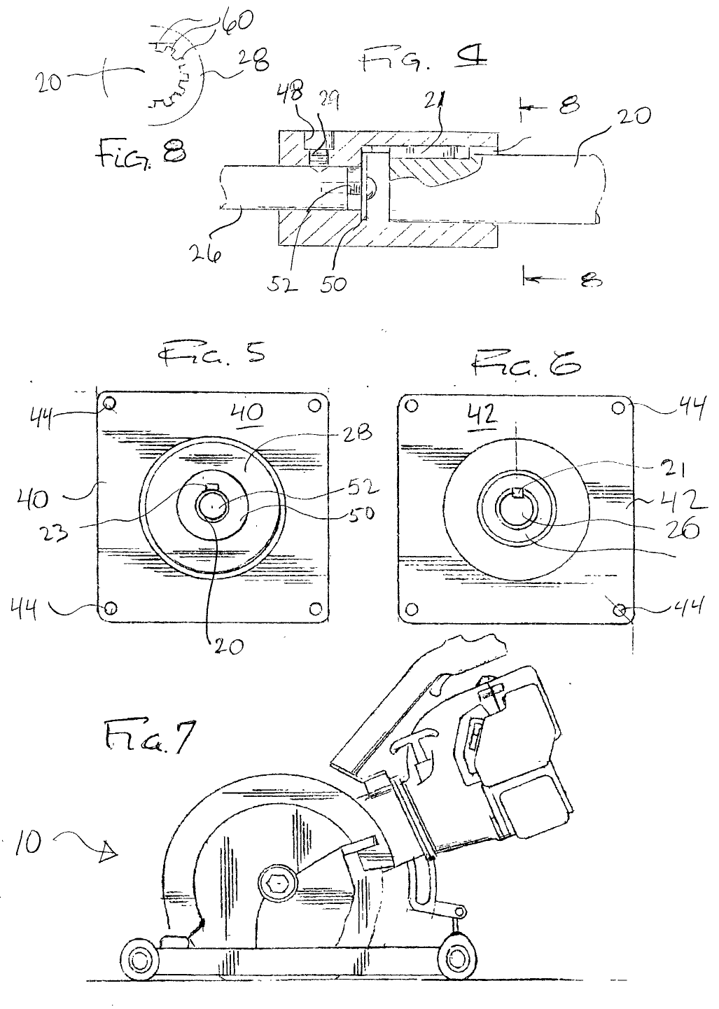

Referring now to FIGS. 2-8, the modular system 10 is shown in the decoupled condition (FIG. 2), to further illustrate the novel features of the present invention. The self-contained power drive system 14 is preferably provided in modular form, for ready, universal application to a power tool head 14 adapted to receive and be driven by power output shaft 26 in the manner to be more fully described. In particular power output drive shaft 26 extends beyond assembly flange 40, and is encompassed along a length thereof by collar 28 secured thereto by a set screw 29. Drive shaft 20 of the power tool head 12 is projected into collar 28 in coaxial arrangement with the power output drive shaft 26, and the power drive system 14 is secured to the power tool head 12 by a counterpart flange 42 secured to flange 40 by threaded or quick-release fasteners 44.

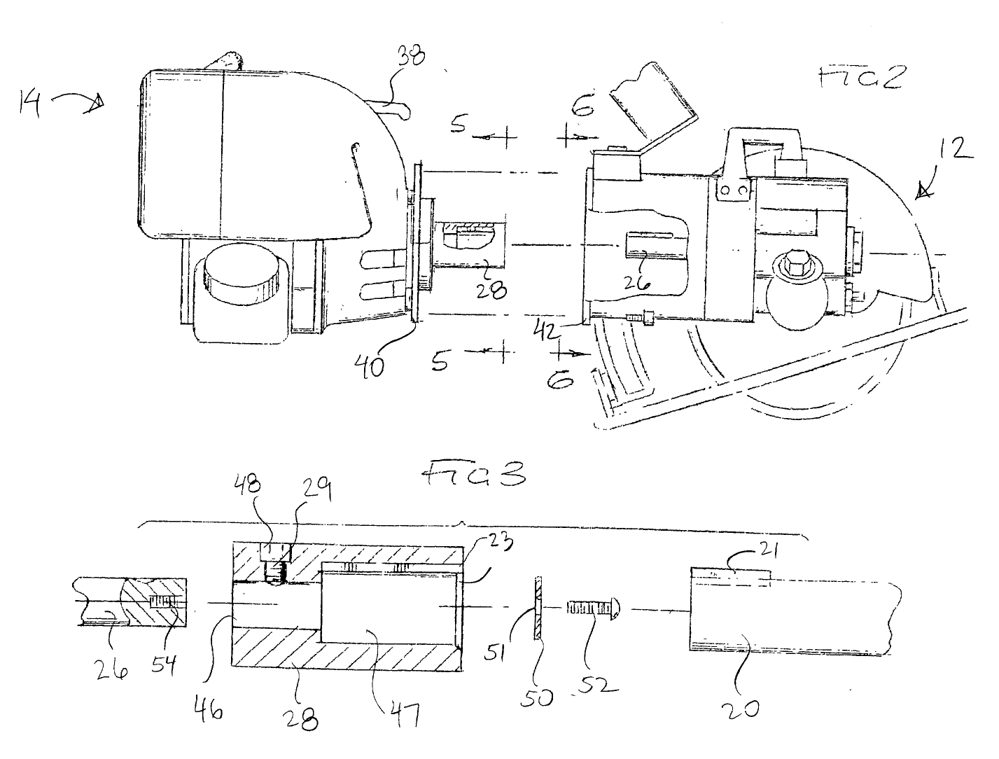

Referring specifically to FIGS. 3-6, power output drive shaft 26 is projected into and secured within bore 46 by set screw 29 projected through bore 48 extending radially into a lateral end of collar 28. Drive shaft 20 of the power tool head 14 is projected into bore 47 coaxial with bore 46. Drive shaft 20 includes tang or key 21 for engaging a counterpart key way 23provided in bore 47 to lock the drive shaft 20 against rotational slippage during operation. Alternatively, bore 47 may be provided with a splined inner periphery to accept and engage tang 21 at any of a plurality of circumferential positions, which would assist during assembly of components 12, 14. Power output drive shaft 26 is secured to collar 28 by a washer 50 having a central opening 51 sized to receive the threaded shaft of fastener 52 that is projected therethrough to engage with bore 54 provided in the distal end 56 of power output drive shaft 26. Accordingly, when components 12, 14 are fully engaged and secured together at flanges 40, 42, power output drive shaft 26 is fully engaged with drive shaft 20 via coupling collar 28.

As will be appreciated by the skilled artisan, power drive shaft 26 may be any power take-off to be engaged with the drive axle 20 or other power point. As shown, and with reference to FIG. 8, power drive shaft 22 is preferably provided with a tang, key or pinion or other take-off that is durable and shock-resistant as necessary to withstand the rigors of the workplace, as well as less-than-perfect linear and rotary mating between coaxially aligned components including spline-receiving recesses 60.

It will be further appreciated that both power-take off and power pick-up points are provided to cooperatively function among related brand or product lines, such interchangeability being important to the field replacement success of the system of the invention. When so mated, the flanges 40, 42 are removably secured together by quick-release fasteners or other fasteners necessary and sufficient to maintain system integrity in the assembled form, while allowing rapid separation for replacement of one or both modular components 12, 14 as the need or desire arises. It will be further appreciated that such modular construction enables the quick changeover between different power tool heads 12 having replacement or different material processing capabilities, or the quick replacement of drive system 14 that is in need of repair or replacement. Alternatively, the modular drive system 14 may be quickly and efficiently replaced with a drive system having a different power or torque specification to meet differing material processing needs. In any case, such modular replaceability allows for easier adaptability to the workplace, whereby separate, modular, power tool heads 12 and drive systems 14 may be stocked for use on an as-required basis, with greater flexibility and adaptability to changed work requirements.

Power drive system 14 may be a self-sufficient gasoline engine acting through a clutch (not shown) to power drive shaft 26. Alternatively, the power drive system 14 may have an electric motor with or without an on-board battery pack (either contained within the modular housing therefore, free-standing, or carried by the operator), or provided with an AC line cord. Of course, it will be appreciated that a fully self-contained power drive system increases the operational mobility of the system 10 in some remote-located circumstances, and the absence of power supply cables enhances that capability. It will be further appreciated that the fuel source used with the modular power source of the present invention may include and not be limited to one or more of the following fuels: ethanol, methanol, alcohol, propane, butane, diesel, natural gas.

It is to be understood that the present invention is not limited to the embodiments described above, but encompasses any and all embodiments within the scope of the following claims.

1. A modular portable power tool system, comprising:
a self-contained power source having a power output element operatively engaged with the power source, and
a tool head removably secured to the power source via the power output element.

2. The tool system as recited in claim 1, wherein the power output element is a drive shaft.

3. The tool system as recited in claim 1, wherein the power output element is a driven gear.

4. The tool system as recited in claim 1, wherein the tool head is selected from the group of material processors including a saw, drill, and sander.

5. The tool system as recited in claim 1, wherein the power output element drives a power input element operatively engaged with the tool head.

6. The tool system as recited in claim 2, wherein the power output element is engaged with the power input element by a collar.

7. The tool system as recited in claim 6, wherein the collar secures the elements with a key and key way connection.

8. The tool system as recited in claim 6, wherein the collar secures the elements with a splined connection.

9. The tool system as recited in claim 1, wherein each modular component includes a concavity opening to a joining flange through which a drive shaft is accessed, the joining flanges secured together at the flanges to enclose the opposing concavities while secure the driving and driven elements in operative condition.

10. The tool system as recited in claim 1, wherein the power source is powered by a fuel selected from the group including ethanol, methanol, alcohol, propane, butane, diesel, and natural gas.

11. A power source for use with a power tool head, comprising:
a self-contained power source having a power output element operatively engaged with the power tool head.

12. The power source as recited in claim 11, wherein the power source is selectively removably secured to the power source via a power output element.

13. The power source as recited in claim 12, wherein the power output element is a drive shaft.

14. The power source as recited in claim 12, wherein the power output element is a driven gear.

15. The power source as recited in claim 12, wherein the power output element is engaged with the power input element by a collar.

16. The power source as recited in claim 15, wherein the collar secures the elements with an operative connection.

17. The power source as recited in claim 15, wherein the power source is powered by a fuel selected from the group including ethanol, methanol, alcohol, propane, butane, diesel, and natural gas.

18. A power tool head for use with a power source, comprising:
a power tool head having a power input element operatively engaged with the power source.

19. The power tool head as recited in claim 18, and a collar for selectively engaging an power input element with a power output element of the power source.
